(19) United States
(12) Patent Application Publication
(10) Pub. No.: US 2025/0079570 A1
(43) Pub. Date: Mar. 6, 2025

(54) BATTERY AND MOTOR VEHICLE WITH BATTERY

(71) Applicant: MAHLE International GmbH, Stuttgart (DE)

(72) Inventors: Dieter Reisinger, Muehlacker (DE); Dragos-Cristian Iancu, Hitzhofen (DE); Thomas Kalmbach, Ostfildern (DE); Eduard Reimer, Fellbach (DE)

(21) Appl. No.: 18/820,253

(22) Filed: Aug. 30, 2024

(30) Foreign Application Priority Data
Sep. 1, 2023 (DE) 10 2023 208 446.5

(51) Int. Cl. H01M 10/6568; B60L 50/64; H01M 10/613; H01M 10/625; H01M 50/213; H01M 50/249; H01M 50/258

(52) U.S. Cl. CPC H01M 10/6568; B60L 50/64; H01M 10/613; H01M 10/625; H01M 50/213; H01M 50/249; H01M 50/258; H01M 2220/20

(57) ABSTRACT

A battery, e.g., a traction battery, is disclosed. The battery includes at least two battery modules. The respective battery module includes a cell volume with battery cells. A fluid distributor is arranged on a first side of the cell volume and an intermediate plate arranged on a side of the fluid distributor facing away from the cell volume. A housing base is arranged on a second side of the cell volume opposite the first side. The housing base has spaced-apart collector openings that fluidically connect the cell volume to a collection volume. A distributor volume decreases along a third direction, and the collection volume decreases in the opposite direction.

### CROSS-REFERENCE TO RELATED APPLICATION

This application claims priority to German Application No. DE 10 2023 208 446.5 filed on Sep. 1, 2023, the contents of which are hereby incorporated by reference in its entirety.

### TECHNICAL FIELD

The present invention relates to a battery, in particular a traction battery, with at least two battery modules, each of which has battery cells. The invention also relates to a motor vehicle with such a battery.

### BACKGROUND

A battery comprises battery cells for providing and storing electrical energy. The number and arrangement of the battery cells is usually adapted to the respective requirements and conditions. To simplify the production of such a battery and/or to flexibly meet the requirements and/or conditions, such a battery can have battery modules with battery cells that are electrically connected to each other within the battery.

Batteries of this type are used in particular for increased power requirements, for example as traction batteries. The battery cells usually require tempering, i.e., cooling and/or heating, especially in the case of increased power requirements. Tempering can be implemented with a cooling medium that flows through the battery and thus regulates the temperature of the battery cells.

The present invention deals with the task of providing improved or at least other embodiments for a battery of the above-mentioned type and for a motor vehicle with such a battery.

According to the invention, this task is solved by the subject matter of the independent claim(s). Advantageous embodiments are the subject of the dependent claims.

### SUMMARY

The present invention is therefore based on the basic idea of forming a volume for admitting a cooling medium to the battery cells and a volume for collecting the cooling medium from the battery cells between successive battery modules in a battery comprising battery modules, wherein the volumes for admitting and the volumes for discharging the cooling medium transversely taper in opposite directions to the flow of the cooling medium into and out of the volumes. As a result, the cooling medium flows evenly in and out of the volumes, such that the battery cells are kept at a uniform temperature. In addition, the pressure of the cooling fluid in the volumes is equalized along the taper of the volumes, resulting in an overall reduction in pressure loss in the volumes and therefore more efficient operation.

In accordance with the idea of the invention, the battery has at least two battery modules which follow one another in one direction. The direction is also referred to below as the first direction. The respective battery module has a limited volume in the battery module to accommodate the battery cells of the battery module, which is also referred to below as the cell volume. The cell volume is open on a first side in a first direction, with a fluid distributor and an intermediate plate arranged on the side of the fluid distributor facing away from the cell volume being arranged on the first side. The fluid distributor and the intermediate plate delimit a volume, which is also referred to below as the distributor volume. On the side facing the intermediate plate, the fluid distributor has at least one fluid connection for introducing a cooling medium into the distributor volume, which is also referred to below as the fluid inlet connection. The respective fluid inlet connection has at least one opening which is fluidically connected to the distributor volume and is also referred to below as the inlet opening. A flow path of the cooling medium thus leads through the respective fluid inlet connection and via the at least one inlet opening into the distributor volume. During operation, the cooling medium therefore flows via the respective fluid inlet connection through the associated at least one inlet opening into the distributor volume. The fluid distributor also has openings in a first direction towards the cell volume, which are spaced apart from one another and connect the distributor volume fluidically to the cell volume. These openings are also referred to below as throttle openings. The flow path then leads from the distributor volume through the throttle openings into the cell volume. During operation, the cooling medium therefore flows from the distributor volume via the throttle openings into the cell volume and thus to the battery cells. The respective battery module also has a housing base on a second side of the cell volume opposite the first side in a first direction, which defines a volume for collecting the cooling medium from the cell volume with the intermediate plate of the next battery module. This volume is also referred to below as the collection volume. The base of the housing has openings that are spaced apart from each other, which fluidically connect the cell volume with the collection volume and are also referred to below as collector openings. This means that the flow path of the cooling medium leads from the cell volume through the collector openings into the collection volume. The housing base also has at least one fluid connection for collecting the cooling medium from the collection volume, which is also referred to below as the fluid outlet connection. The respective fluid outlet connection has at least one opening which fluidically connects the fluid outlet connection to the collection volume and is also referred to below as the outlet opening. Thus, the flow path of the cooling medium leads from the collection volume through the respective outlet opening into the at least one fluid outlet connection. The at least one fluid inlet connection with the at least one inlet opening is spaced apart from the at least one fluid outlet connection with the at least one outlet opening in a third direction extending transversely to the first direction. The respective distributor volume decreases along the third direction, starting from at least one of the at least one inlet openings. In addition, the respective collection volume decreases in the opposite direction from at least one of the at least one outlet openings along the third direction and the distributor volume.

The arrangement of the throttle openings is such that the cooling medium flows homogeneously into the cell volume. The throttle openings are therefore arranged in such a way that the cooling medium flows homogeneously around the battery cells.

The arrangement of the collector openings is such that the cooling medium flows homogeneously out of the cell volume.

During operation, the cooling medium is used for tempering, i.e., to cool and/or heat the battery cells. For this purpose, the battery cells can be immersed in the cooling medium. Tempering therefore takes place in the form of so-called immersion cooling. The cooling medium is advantageously a dielectric liquid.

The battery cells can be of any type.

In particular, the battery cells are electrochemical battery cells.

In particular, the battery cells can be designed as round cells that extend longitudinally along the first direction.

The housing base of the respective battery module preferably delimits the cell volume of the battery module in a first direction.

The respective battery module advantageously has a housing that delimits the cell volume with the housing base, which is also referred to below as the module housing.

The module housing is preferably closed on the first side by the fluid distributor. The fluid distributor therefore forms a housing cover for the module housing. The fluid distributor therefore combines the function of fluid distribution and the housing cover. This results in a considerably simplified and cost-effective production of the battery, while at the same time reducing the installation space required.

The battery can be used in any application. In particular, the battery can be used in a motor vehicle.

In particular, the battery is a traction battery. In a motor vehicle, the battery is therefore used to drive the vehicle, for example by means of at least one electric motor.

As explained above, at least two such battery modules are arranged consecutively in the battery.

The battery therefore has two battery modules arranged on the outside in a first direction, which are also referred to below as the first outer battery module and the second outer battery module.

On the side facing away from the intermediate plate of the first outer battery module in a first direction, a first end plate is preferably arranged, which has a fluid inlet for the respective fluid inlet connection of the outermost battery module for admitting the cooling medium into the battery. The respective at least one fluid inlet is fluidically connected to the associated fluid inlet connection of the first outer battery module. Advantageously, the respective at least one fluid inlet is plugged into the associated fluid inlet connection of the first outer battery module.

The battery preferably has a second end plate on the side facing away from the cell volume of the second outer battery module in a first direction. The second end plate is therefore arranged on the side of the housing base of the second outer battery module facing away from the fluid distributor of the second outer battery module in a first direction. The second end plate with the housing base of the second outer battery module can delimit the collection volume for the second outer battery module. This means that, in contrast to the other battery modules, the collection volume of the second outer battery module can be delimited not by the housing base and the intermediate plate of the adjacent battery module, but by the housing base and the second end plate. Alternatively, such an intermediate plate can be arranged between the second end plate and the housing base of the second outer battery module, which delimits the collection volume of the second outer battery module with the housing base. In contrast to the other battery modules, the collection volume in this case is not delimited by the housing base and the intermediate plate of the neighboring battery module, but by the separately provided intermediate plate.

The second end plate preferably comprises at least one fluid outlet for removing the cooling medium from the battery. The fluid outlet is fluidically connected to the at least one fluid outlet connection of the second outer battery module. Preferably, the at least one fluid outlet is plugged into the at least one fluid outlet connection of the second outer battery module.

The respective intermediate plate is preferably designed to be thermally insulating, in particular as a thermal barrier. For this purpose, the intermediate plate is expediently made of a material/raw material with low thermal conductivity, in particular consists of such a material/raw material. Preferably, the intermediate plate is made of mica, also known as “glimmer”, and consists in particular of mica. This results in reduced heat transfer between the distributor volume and the collection volume. This results in increased tempering efficiency.

In the battery, the fluid inlet connections of the battery modules are preferably fluidically connected to each other and the fluid outlet connections of the battery modules are fluidically connected to each other. This means that the cooling medium in the battery also flows to the neighboring battery modules via the fluid inlet connections. This also means that the cooling medium in the battery is routed to the neighboring battery modules via the fluid outlet connections. In this case, the fluid inlet connections are conveniently fluidically separated from the fluid outlet connections or only connected via the throttle openings and outlet openings. The fluid inlet connections of the battery modules are therefore preferably fluidically connected, in particular plugged, separately from the cell volumes. Moreover, the fluid outlet connections of the battery modules are fluidically connected, in particular plugged, separately from the cell volumes.

Preferred embodiments are those in which the fluid distributor on the side facing the intermediate plate has fins protruding in a second direction and spaced apart in a first direction, which are also referred to below as distributor fins. Preferably, the intermediate plate lies on the distributor fins to form the distributor volume.

Preferably, the base of the housing on the side facing away from the cell volume has fins protruding in a second direction and spaced apart in a first direction, which are also referred to below as collector fins. Preferably, the intermediate plate of the next battery module or the intermediate plate arranged between the housing base and the second end plate lies on the collector fins in the battery to form the collection volume.

The decrease in the respective distributor volume and collection volume can be implemented in any way.

In preferred embodiments, the volumes are removed by means of an inclined arrangement of the intermediate plate. This means that the respective intermediate plate runs inclined to the third direction, such that the respective distributor volume decreases along the third direction and the respective collection volume decreases along the third direction in the opposite direction to the distributor volume. This makes it particularly easy to taper the volumes while reducing the installation space. This also reduces thermal losses and thus increases efficiency.

The inclined arrangement of the respective intermediate plate can be implemented in any way.

The distributor fins have a height running in a first direction, which is also referred to below as the distributor fin height.

Preferably, the distributor fin height of the distributor fins decreases along the third direction starting from at least one of the at least one inlet openings. This results in a correspondingly inclined arrangement of the intermediate plate lying on the distributor fins. This means that the intermediate plate is therefore inclined towards the third direction and the distributor volume decreases along the third direction. This results in a simple implementation of the decreasing distributor volume and at the same time a mechanically stable arrangement of the intermediate plate and formation of the distributor volume.

The first end plate has an inner surface facing the intermediate plate of the first outer battery module in a first direction, which is also referred to below as the inner surface of the first end plate. The intermediate plate of the first outer battery module lies advantageously on the inner surface of the end plate.

In preferred embodiments, the first inner end plate surface is inclined towards the third direction, such that the distributor volume of the first outer battery module decreases along the third direction due to the intermediate plate lying on the inner surface of the first end plate.

The collector fins have a height that runs in a first direction, which is also referred to below as the collector fin height.

In preferred embodiments, the collector fin height decreases along the third direction starting from at least one of the at least one outlet openings, such that the intermediate plate lying on the collector fins runs inclined to the third direction and the collection volume decreases along the third direction. This results in a simple implementation of the decreasing collection volume and at the same time a mechanically stable arrangement of the intermediate plate and formation of the collection volume.

The second end plate has an inner surface facing the housing base of the second outer battery module in a first direction, which is also referred to below as the second end plate inner surface. The second end plate inner surface thus faces an intermediate plate arranged between the second end plate and the housing base of the second outer battery module, wherein the intermediate plate preferably lies on the second end plate inner surface.

In preferred embodiments, the second end plate inner surface is inclined towards the third direction, such that the collection volume of the second outer battery module decreases in the opposite direction along the third direction and the distributor volume.

Preferably, the respective distributor fin is interrupted along the third direction, i.e., has at least one interruption along the third direction, which is also referred to below as a distributor interruption. Accordingly, the flow path leads through at least one distributor interruption within the distributor volume. This results in a more homogeneous flow of the cooling medium through the distributor volume and via the throttle openings to the battery cells. This means that a more homogeneous tempering of the battery cells and the respective battery module as well as the battery is achieved.

The respective collector fin is advantageously interrupted in a third direction, i.e., has at least one interruption in a third direction, which is also referred to below as a collector interruption. The flow path therefore leads through the collector interruptions within the collection volume. This results in a more homogeneous flow of the cooling medium through the collection volume and thus an overall more homogeneous flow through the respective battery module and through the battery. This means that the battery cells of the respective module and the battery are tempered more homogeneously.

At least one of the collector fins may have a main section extending along or inclined to the third direction, from which at least two arms project, wherein such a collector opening is arranged between at least two of the arms. With the arms and the main section, there is a directed flow of the cooling medium through the collection volume, which leads to a more homogeneous flow through the collection volume and thus to a more homogeneous flow of the cooling medium out of the cell volume. This results in a more homogeneous tempering of the battery cells.

In preferred embodiments, the battery cells in the respective battery module are supported on the associated housing base or lie on the housing base. This is preferably done in such a way that the flow path is delimited by the undersides of at least some of the battery cells facing the housing base. This means that the cooling medium flows along these undersides during operation and is in contact with them. This results in improved tempering of the battery cells.

Advantageously, the at least one fluid inlet connection with the at least one inlet opening is arranged along the third direction in an edge of the distributor volume extending along the second direction, which is also referred to below as the first edge. The decrease in distributor volume thus extends over essentially the entire extension of the distributor volume in a third direction.

The at least one fluid outlet connection is preferably arranged with the at least one outlet opening along the third direction in an edge of the collection volume extending along the second direction and opposite the first edge in a third direction, which is hereinafter also referred to as the second edge. The decrease in the collection volume thus extends over essentially the entire length of the collection volume in a third direction.

It is understood that, in addition to the battery, a motor vehicle with the battery as such is also included in the scope of the present invention.

In the motor vehicle, the first direction preferably runs transverse to a Z-direction of the motor vehicle. In particular, the first direction runs along a Y-direction and thus transverse to the direction of travel of the motor vehicle.

Further important features and advantages of the invention are apparent from the sub-claims, from the drawings, and from the associated description of the figures with reference to the drawings.

It is understood that the features mentioned above and those to be explained below can be used not only in the combination indicated in each case, but also in other combinations or on their own, without departing from the scope of the present invention.

Preferred embodiments of the invention are shown in the drawings and are explained in more detail in the following description, with identical reference signs referring to identical or similar or functionally identical components.

### BRIEF DESCRIPTION OF THE DRAWINGS

It shows, in each case schematically

FIG. 1 an isometric view of a battery with consecutive battery modules and a dismantled battery module in an exploded view,

FIG. 2 an enlarged view of FIG. 1 in the area of battery cells of the dismantled battery module,

FIG. 3 a sectional view of the battery,

FIG. 3a an enlarged view of a section of FIG. 3,

FIG. 4 an isometric view of a fluid distributor of a battery module,

FIG. 5 another isometric view of the fluid distributor,

FIG. 6 an isometric view of a housing base of the battery module,

FIG. 7 another isometric view of the housing base,

FIG. 8 an isometric, exploded view of the battery module towards such a fluid distributor,

FIG. 9 an isometric, exploded view of the battery module towards such a housing base.

### DETAILED DESCRIPTION

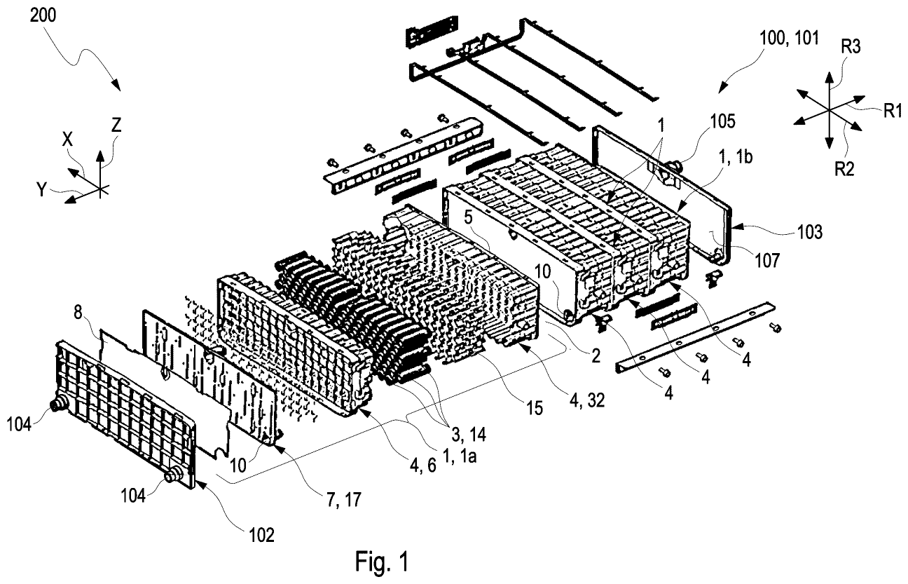

A battery 100, as shown by way of example in FIGS. 1 to 3, 3a, has battery modules 1, as shown by way of example in FIGS. 1 to 3, 3a, and 8 and 9. The battery 100 is in particular a traction battery 101 for a battery-electric motor vehicle 200 indicated in FIG. 1 and otherwise not shown. The battery 100 has at least two, advantageously several, such battery modules 1. In the embodiment example shown in FIGS. 1 to 3, the battery 100 has four such battery modules 1 by way of example only. The battery modules 1 are arranged in sequence along a direction R1 (direction 1), which is also referred to below as the first direction. In the embodiment examples shown, the battery modules 1 are stacked in a first direction R1, in particular plugged together, and thus mounted together. The battery 100 has two outer battery modules 1 along the first direction R1, namely a first outer battery module 1, la and a second outer battery module 1, 1b opposite the first outer battery module 1, la. In the illustration in FIG. 1, the three battery modules 1 shown on the right are shown in an assembled state and mounted or stacked together, whereas the fourth battery module 1 shown on the left, which corresponds to the first outer battery module 1, la in the illustration, is pulled apart and thus shown in an exploded view.

When the battery 100, in particular the traction battery 101, is used in the motor vehicle 200, the first direction R1 advantageously runs transversely to a Z direction Z of the motor vehicle 200 and in particular along a Y direction Y of the motor vehicle 200 and thus transversely to the X direction X and consequently transversely to the direction of travel.

In the examples shown, the individual battery modules 1 are purely exemplary cuboid in shape. FIG. 1 shows further peripheral components of the battery 100, which are not defined in detail and can be used, for example, for electrical contacting and for attaching the battery modules 1 to each other.

One of the battery modules 1 is defined below. Since the battery modules 1 have the same design, the description can be applied analogously to the other battery modules 1.

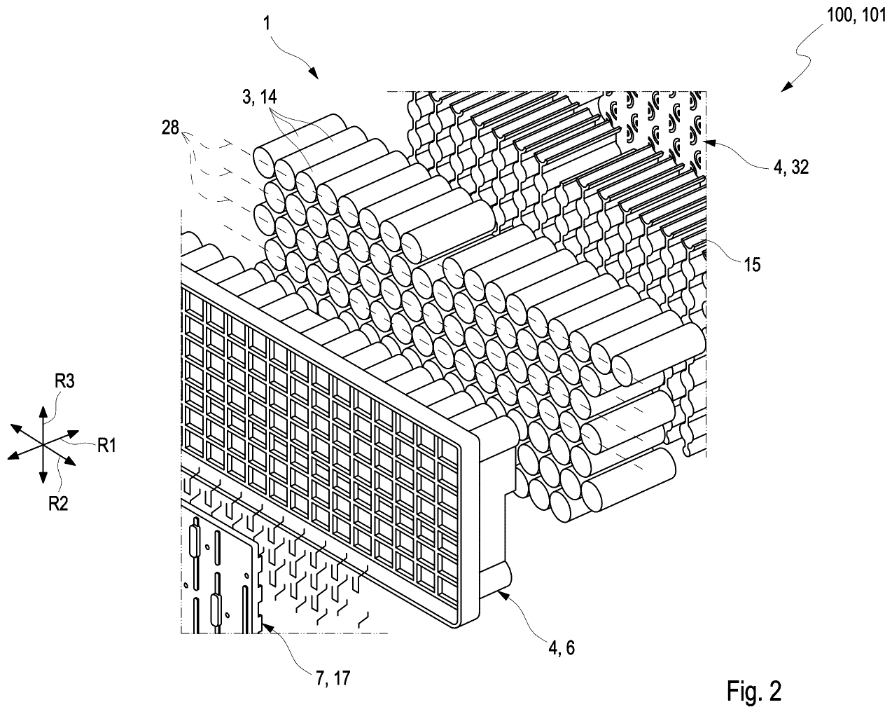

The battery module 1 has a volume 2 in which electrochemical battery cells 3 are accommodated. Volume 2 is also referred to below as cell volume 2. As can be seen from FIG. 1, the respective battery module 1 can have a holding structure 15, which holds and fixes the battery cells 3 in the cell volume 2. In the embodiment examples shown, the battery module 1 has a housing 4, which is also referred to below as the module housing 4 and defines the cell volume 2 and thus accommodates the battery cells 3. In the embodiment examples shown, as can be seen in particular in FIG. 2, the battery cells 3 are designed as so-called round cells 14, which have a cylindrical shape and extend longitudinally along the first direction R1. The battery cells 3 can be arranged in the cell volume 2 in a second direction R2 running transverse to the first direction R1 and in a third direction R3 running transverse to the first direction R1 and transverse to the second direction R2 in succession or next to each other.

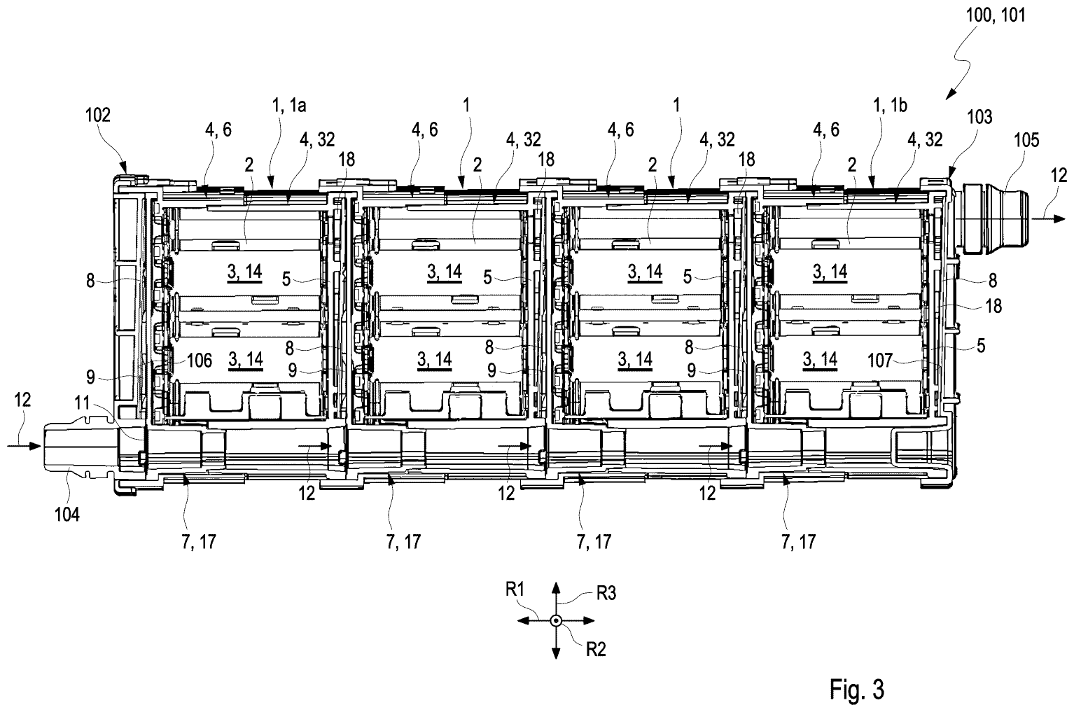

In the embodiments shown, the module housing 4 has a lower housing part 32 with a housing base 5 and an upper housing part 6 following the lower housing part 5 in a first direction R1, which delimit the cell volume 2. The battery cells 3 of the battery module 1 can be supported on the housing base 5. The cell volume 2 is open along the first direction R1 on one side, which is also referred to below as the first side. This also means that the module housing 4 is open on the first side, i.e., opposite the housing base 5 along the first direction R1 in the embodiment examples shown. On the first side and thus opposite the housing base 5 in a first direction R1, the battery module 1 has a fluid distributor 7, which is plate-shaped. In the embodiment examples shown, the fluid distributor 7 closes the module housing 4 on the first side and is thus also designed as a housing cover 17 that closes the module housing 4. On the side of the fluid distributor 7 facing away from the cell volume 4 and thus from the battery cells 2, the battery module 1 has a plate 8, which is also referred to below as intermediate plate 8. As can be seen in FIG. 3, the fluid distributor 7 and the intermediate plate 8 delimit a volume 9, which is also referred to below as the distributor volume 9.

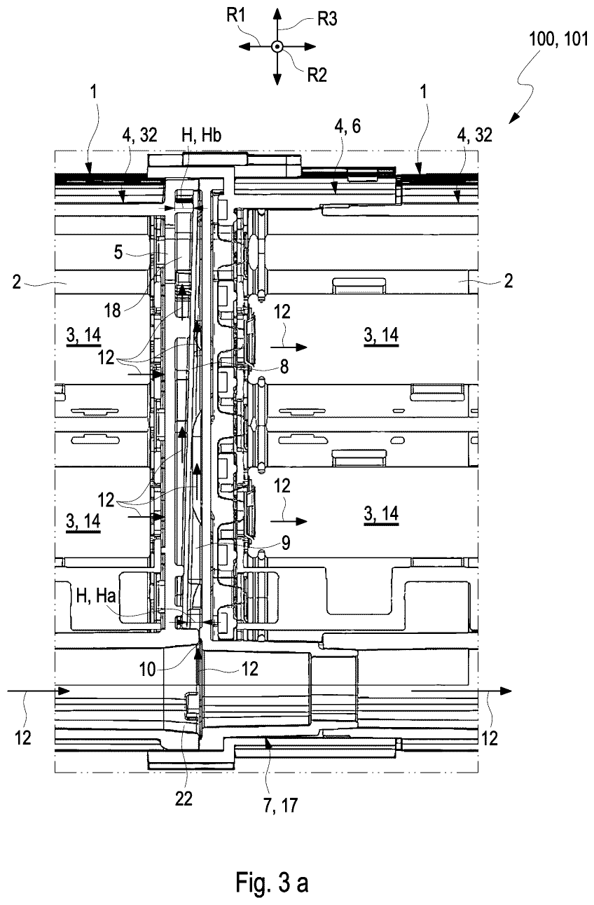

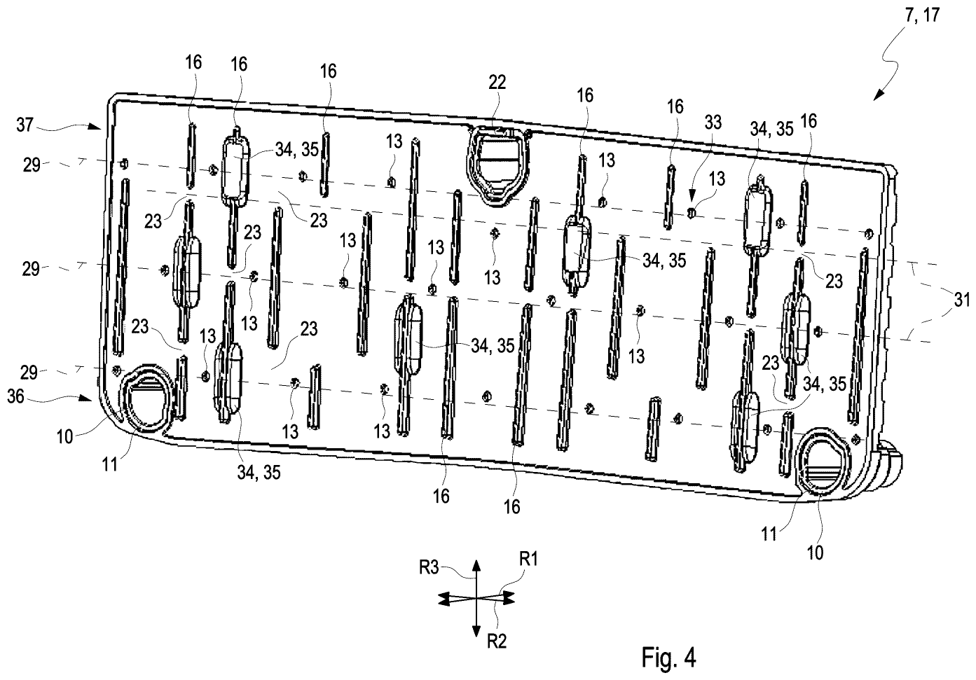

FIGS. 4 and 5 show isometric views of the fluid distributor 7, with FIG. 4 showing an isometric view of the fluid distributor 7 towards the side facing the intermediate plate 8 and FIG. 5 showing an isometric view of the fluid distributor 7 towards the side facing the cell volume 2. As can be seen in particular from FIGS. 4 and 5, the fluid distributor 7 has at least one fluid connection 10 on the side facing the intermediate plate 8, which is also referred to below as fluid inlet connection 10. In the embodiment examples shown, the fluid distributor 7 has two such fluid inlet connections 10, which are spaced apart from one another along the second direction R2 and are arranged at the edge of the distributor volume 9 in a second direction R2 and in a third direction R3. The fluid inlet connections 10 are thus arranged along the third direction R3 in an edge 36 of the distributor volume 9 extending along the second direction R2, which is also referred to below as the first edge 36. The respective fluid inlet connection 10 has at least one opening 11 through which a cooling medium can flow into the distributor volume 9 via the fluid inlet connection 10, and which is also referred to below as inlet opening 11. The respective fluid inlet connection 10 thus has at least one inlet opening 11, which is fluidically connected to the distributor volume 9, such that a flow path 12 of the cooling medium leads through the respective fluid inlet connection 10 and via the at least one inlet opening 11 into the distributor volume 9. The respective inlet opening 11 therefore preferably opens into the distributor volume 9. The fluid distributor 7 has open and spaced openings 13 in a first direction R1 towards the cell volume 2, which are also referred to below as throttle openings 13. During operation, the cooling medium flows from the distributor volume 9 into the cell volume 2 and thus to the battery cells 3 via the throttle openings 13. The throttle openings 13 therefore fluidically connect the distributor volume 9 with the cell volume 2, such that the flow path 12 leads from the distributor volume 9 through the throttle openings 13 into the cell volume 2. In this way, a more homogeneous flow of the cooling medium into the cell volume 2 and thus a more homogeneous tempering, in particular a more homogeneous cooling of the battery cells 3, can be achieved.

In the embodiments shown, the battery modules 1 and thus the battery 100 are immersion-tempered. This means that the battery cells 3 are immersed in the cooling medium during operation. The cooling medium is advantageously a dielectric liquid.

In the embodiments shown, as can be seen in FIGS. 1 and 3, the battery modules 1 are arranged along the first direction R1 between two end plates 102, 103, namely between a first end plate 102 and a second end plate 103. The first end plate 102 is arranged on the side of the intermediate plate 8 of the first outer battery module 1, 1a facing away from the cell volume 2 or the fluid distributor 7. The second end plate 103 is arranged on the side of the housing base 5 of the second outer battery module 1, 1b facing away from the cell volume 2.

As can be seen in particular from FIG. 3, in the embodiments shown, the respective housing base 5 with the intermediate plate 8 of the adjacent battery module 1 delimits a volume 18, which is also referred to below as the collection volume 18. In the embodiment examples shown, this applies to all housing bases 5 with the exception of the housing base 5 of the second outer battery module 1, lb. Together with an additional intermediate plate 8 arranged between the housing base 5 and the second end plate 103, this housing base 5 forms the associated collection volume 18.

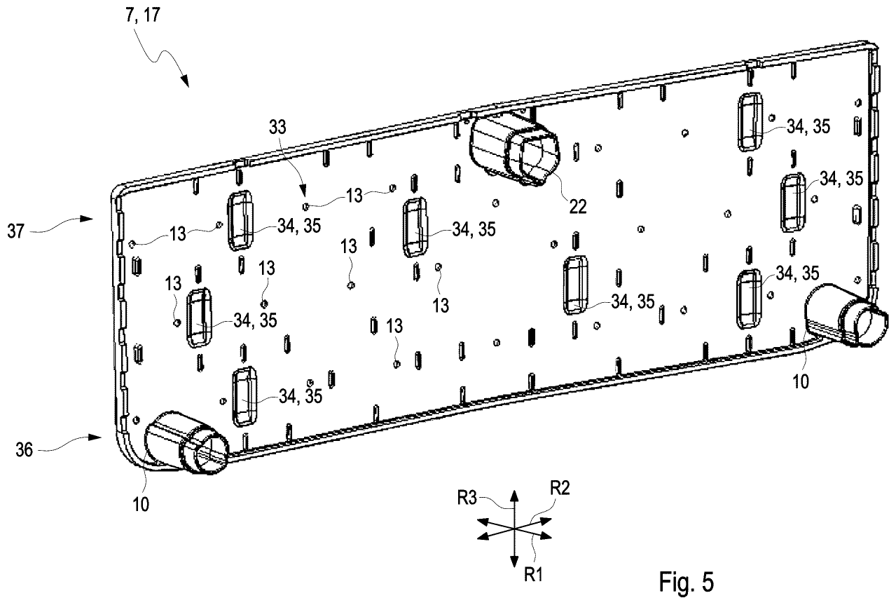

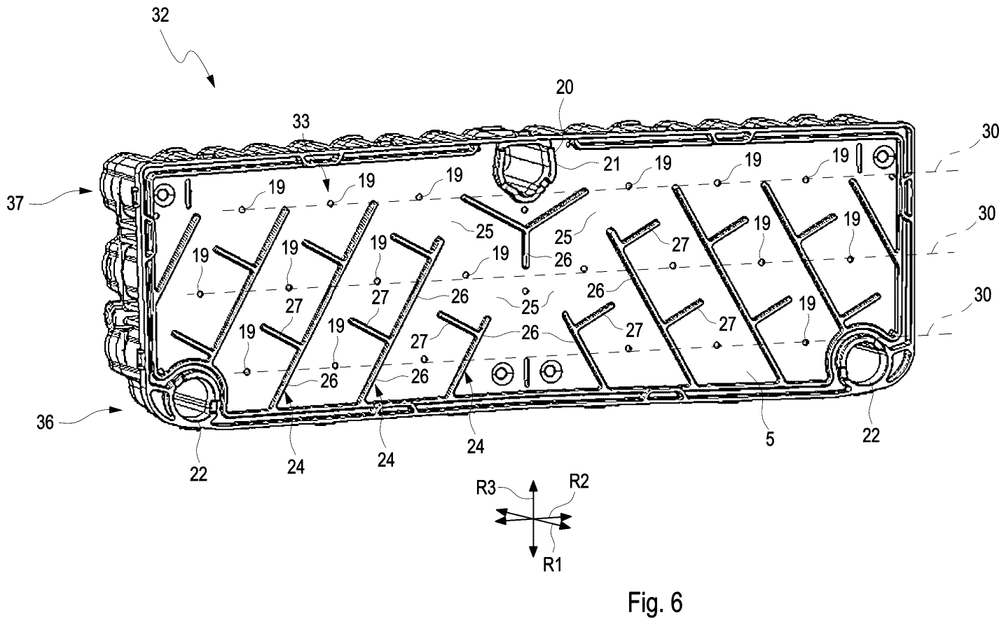

FIGS. 6 and 7 show isometric views of the housing base 5, with FIG. 6 showing a view towards the side of the housing base 5 facing away from the cell volume 2 and FIG. 7 showing a view towards the side of the housing base facing the cell volume 2. As can be seen in particular from FIGS. 6 and 7, the housing base 5 in the embodiments shown has openings 19 spaced apart from one another, which fluidically connect the cell volume 2 to the collection volume 18. These openings 19 are also referred to below as collector openings 19. As a result, the cooling medium flows out of the cell volume 2 into the collection volume 18 via the collector openings 19 during operation. This means that the flow path 12 leads from the cell volume 2 through the collector openings 19 into the collection volume 18. This also results in a more homogeneous flow of the cooling medium from the cell volume 2 and thus a more homogeneous tempering, in particular a more homogeneous cooling of the battery cells 3. As can be seen in particular from FIGS. 6 and 7 as well as 9, the housing base 5 in the embodiments shown has at least one fluid connection 20 for collecting the cooling medium from the collection volume 18, which is also referred to below as fluid outlet connection 20. The respective fluid outlet connection 20 has at least one opening 21 connected to the collection volume 18, which is also referred to below as outlet opening 21. Thus, during operation, the cooling medium flows out of the collection volume 18 via the respective at least one outlet opening 21 into the at least one fluid outlet connection 20 and thus out of the battery module 1. In the embodiment examples shown, the housing base 5 has a single such fluid outlet connection 20. In the embodiments shown, the fluid outlet connection 20 is spaced apart from the fluid inlet connections 10 in a third direction R3 and is arranged at the edge. In the embodiments shown, the at least fluid outlet connection 20 is thus arranged along the third direction R3 in a second edge 37 of the collection volume 18, which extends along the second direction R2 and is arranged opposite the first edge 36 in a third direction R3. In the embodiment examples shown, the fluid outlet connection 20 is arranged centrally in a second direction R2.

In the embodiment examples shown, the throttle openings 13 are formed as a hole pattern 33 in the fluid distributor 7. In the embodiments shown, the collector openings 19 are also formed as a hole pattern 33 in the housing base 5.

As can be seen from FIGS. 3, the respective distributor volume 9 decreases along the third direction R3 starting from the inlet openings 11 and thus starting from the fluid inlet connections 10. In the embodiment examples shown, the respective distributor volume 9 therefore decreases starting from the first edge 36 along the third direction R3 and thus towards the second edge 37. The decrease in distributor volume 9 is essentially continuous. In the embodiments shown, the respective collector volume 18 also decreases in the opposite direction along the third direction R3 and the distributor volume 9, starting from the at least one outlet opening 21 and thus starting from the fluid outlet connection 20. In the embodiments shown, the respective collection volume 18 thus decreases starting from the second edge 37 along the third direction R3 and thus towards the first edge 36.

As can be seen from FIGS. 3 and 4, in the embodiments shown, the fluid distributor 7 has fins 16 projecting in a first direction R1 and spaced apart in a second direction R2 on the side facing the intermediate plate 8, on which the intermediate plate 8 rests to form the distributor volume 9. The fins 16 are also referred to below as distributor fins 16. In the embodiments shown, the respective distributor fin 16 has at least one interruption 23 along the third direction R3, which is also referred to below as distributor interruption 23. The cooling medium can therefore flow through the distributor volume 9 via the distributor interruptions 23. This means that the flow path 12 in the distributor volume 9 leads through the distributor interruptions 23. This results in further homogenization of the flow of the cooling medium through the throttle openings 13 and consequently into the cell volume 2 and to the battery cells 3.

As can be seen from FIGS. 3 and 6, in the embodiment examples shown, the housing base 5 has fins 24 on the side facing away from the cell volume 2 that protrude in a first direction R1 and are spaced apart in a second direction R2, which are also referred to below as collector fins 24. As can be seen in FIG. 3, for example, the intermediate plate 8 of the adjacent battery module 1 or the intermediate plate 8 between the second outer battery module 1, 1b and the second end plate 103 lies on the collector fins 24 to form the collection volume 18. As can be seen in FIG. 6, the respective collector fin 24 has at least one interruption 25 along the third direction R3, which is also referred to below as collector interruption 25. The flow path 12 leads through the collector interruptions 25 in the collection volume 18. This allows the fluid to flow through the collection volume 18 via the collector interruptions 25. The flow path 12 thus leads through the collector interruptions 25 in the collection volume 18. As a result, the flow of the cooling medium through the collector openings 19 and thus out of the cell volume 2 is further homogenized. In the embodiment example shown in FIG. 6, the respective collector fin 24 has such a collector interruption 24 by way of example only.

As can be seen from FIG. 6, at least one of the collector fins 24 can have a main section 26 running along or inclined to the third direction R3, from which at least two arms 27 protrude. Such a collector opening 19 is arranged between at least two such arms 27. In the embodiments shown, several collector fins 24 have such main sections 26 and arms 27.

The decrease of the respective distributor volume 9 and collector volume 18 is realized by means of the intermediate plates 8 in the embodiment examples shown. For this purpose, the respective intermediate plate 8 runs inclined to the third direction R3, such that the respective associated distributor volume 9 and collection volume 18 decrease in opposite directions along the third direction R3 as defined.

In the design examples shown, this is achieved by means of the heights H of the fins 16, 24 running in a third direction R3 (see FIG. 3a). This means that a distributor fin height H, Ha of the distributor fins 16 extending in a first direction R1 decreases along a third direction R3 starting from at least one of the at least one inlet openings 11, such that the intermediate plate 8 extends inclined to a third direction R3 and the distributor volume 9 decreases along a third direction R3. In addition, a collector fin height H, Hb of the collector fins 24 extending in a first direction R1 decreases along a third direction R3 starting from at least one of the at least one outlet openings 21, such that the intermediate plate 8 extends inclined to a third direction R3 and the collection volume 18 decreases in the opposite direction along a third direction R3 and the distributor volume 9.

In order to also achieve the decrease in the distributor volume 9 of the first outer battery module 1, la, the first end plate 102 extends with an inner surface 106 facing the intermediate plate 8 of the first outer battery module 1, la inclined towards the third direction R3. The inner surface 106 is hereinafter also referred to as the first end plate inner surface 106. Here, as defined above, the intermediate plate 8 lies on the first end plate inner surface 106 or is supported thereon, such that the distributor volume 9 of the first outer battery module 1, la decreases along the third direction R3 as defined. To implement the decrease in the collection volume 18 of the second outer battery module 1, 1b, an inner surface 107 of the second end plate 103 facing the housing base 5 of the second outer battery module 1, 1b extends inclined to the third direction R3. This inner surface 107 is also referred to below as the second end plate inner surface 107. The intermediate plate 8 arranged between the housing base 5 of the second outer battery module 1, 1b and the second end plate 103 lies on the second end plate inner surface 107 or is supported thereon, such that the collection volume 9 of the second outer battery module 1, 1b decreases along the third direction R3 as defined.

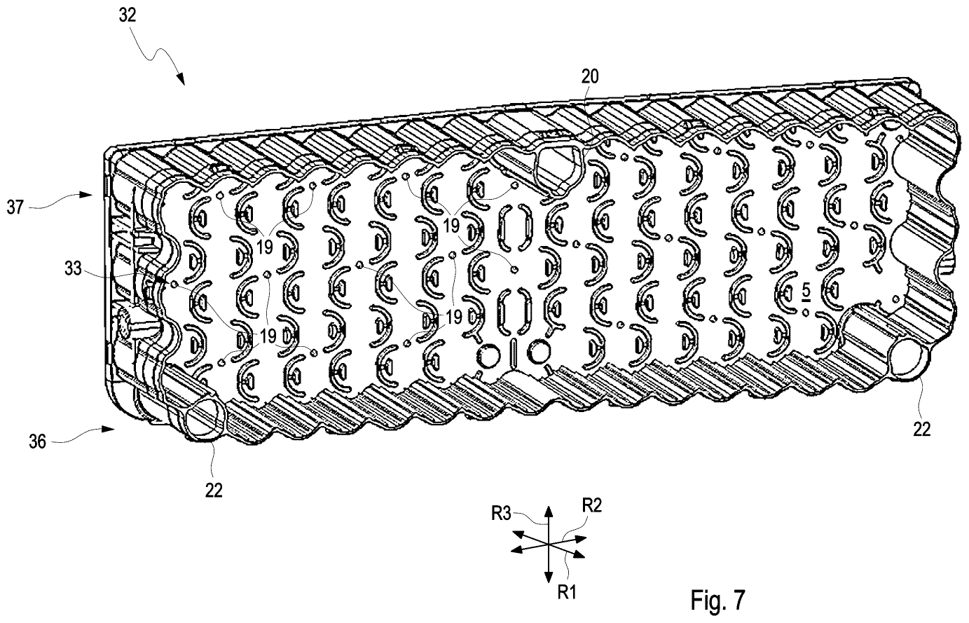

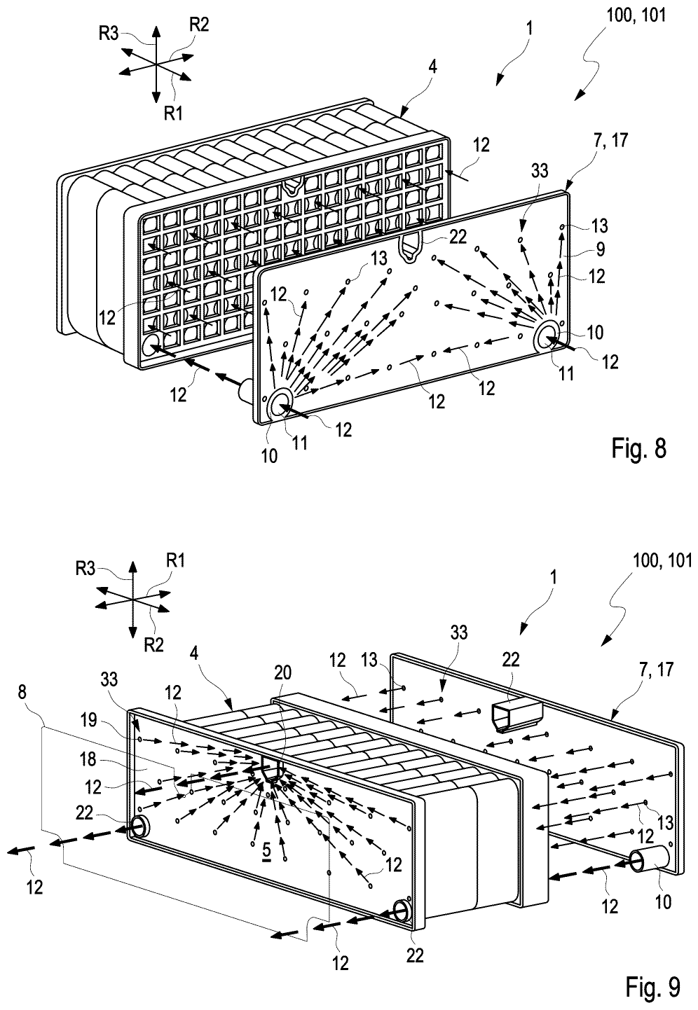

As can be seen in particular in FIG. 3, in the embodiments shown, the fluid inlet connections 10 of the battery modules 1 within the battery 100 are fluidically connected to one another. For this purpose, the fluid inlet connections 10 also extend to the side facing the cell volume 2 in the embodiment examples shown. The fluid inlet connections 10 are fluidically separated from the cell volumes 2. This means that the cooling medium, as indicated by the flow paths 12 shown in FIGS. 8 and 9, flows from the first outer battery module 1, la to the second outer battery module 1, 1b by means of the fluid inlet connections 10 and only flows into the cell volumes 2 by means of the associated fluid distributors 7 and throttle openings 13. Similarly, in the embodiment examples shown, the fluid outlet connection 20 of the battery modules 1 is fluidically connected to one another within the battery 100, but is fluidically separated from the cell volumes 2. For this purpose, in the embodiment examples shown, the respective fluid outlet connection 20 also extends to the side facing the cell volume 2. This means that the cooling medium, as indicated by the flow paths 12 in FIGS. 8 and 9, flows from the first outer battery module 1, la to the second outer battery module 1, 1b via the fluid outlet connections 20 and only flows from the cell volumes 2 into the respective associated collection volume 18 by means of the collector openings 19 and from the respective collection volumes 18 via the at least one associated outlet opening 21 into the at least one associated fluid outlet connection 20. In the illustrations in FIGS. 8 and 9, the flows between the fluid inlet connections 10 and the flows between the fluid outlet connections 20 are shown with large/thick arrows for the flow path 12 and the flows through the distributor volumes 9, through the cell volumes 2 and through the collection volumes 18 are shown with smaller/thinner arrows for the flow path 12 to make it easier to distinguish between them.

In the embodiment examples shown, the fluidic connections of the fluid inlet connections 10 and the fluidic connections of the fluid outlet connections 20 are implemented by means of plug-in connections. This means that the fluid inlet connections 10 are plugged into each other. The fluid outlet connections 20 are also plugged into each other. For fluidic connection of the fluid outlet connections 20 of the neighboring battery modules 1 to one another, the fluid distributor 7 in the embodiment examples shown has an associated passage connection 22 for the respective fluid outlet connection 20 of the housing base 5, i.e., a single passage connection 22 in the embodiment examples shown, which is fluidically separated from the distributor volume 9 and cell volume 2 and is fluidically connected to the fluid outlet connection 20 of the neighboring battery module 1, plugged in the embodiment examples shown. Likewise, the housing base 5 for fluidic connection of the fluid inlet connections 10 of the adjacent battery modules 1 to one another has an associated passage connection 22 for the respective fluid inlet connection 10, i.e., two passage connections 22 in the embodiment examples shown. The respective passage connection 22 of the housing base 5 is fluidically separated from the collection volume 18 and the cell volumes 2 and fluidically connected to the associated fluid inlet connection 10 of the adjacent battery module 1, in the embodiment examples shown. In the embodiments shown, the intermediate plate 8 is recessed in the area of the respective connection 10, 20, 22 (see, for example, FIG. 1).

For example, it can be seen from FIGS. 1 and 3 that in the embodiments shown, the first end plate 102 has at least one fluid inlet 104 for introducing the cooling medium into the battery 1. In the embodiments shown, the first end plate 102 thus has at least one such fluid inlet 104 for introducing the cooling medium into the distributor volume 9 of the first outer battery module 1, 1a. The respective fluid inlet 104 can be arranged on the pressure side of a conveying device not shown, for example a pump, for conveying the cooling medium. In the embodiments shown, the first end plate 102 for the respective fluid inlet port 10 of the first outer battery module 1, la has an associated fluid inlet 104, i.e., two fluid inlets 104. The respective fluid inlet 104 is fluidically connected to an associated one of the fluid inlet connections 10 of the first outer battery module 1, plugged in the embodiment example shown. As a result, the cooling medium flows during operation via the respective fluid inlet 104 into the associated fluid inlet connection 10 of the first outer battery module 1, la and into the distributor volume 9 of the first outer battery module 1, la as well as to the other battery modules 1 by means of the fluidic connections of the fluid inlet connections 10 defined above.

As can also be seen in FIGS. 1 and 3, for example, the second end plate 103 has at least one fluid outlet 105 for discharging the cooling medium from the battery 1, to which the respective fluid outlet connection 20 is fluidically connected. The respective fluid outlet 105 can therefore be arranged on the suction side of the delivery device, in particular the pump. In the embodiments shown, the second end plate 103 has an associated fluid outlet 105, i.e., a single fluid outlet 105, for the respective fluid outlet port 20 of the second outer battery module 1, lb. The fluid outlet 105 is fluidically connected to the fluid outlet connection 20 of the second outer battery module 1, 1b, in the embodiment examples shown. The fluid outlet 105 is thus also fluidly connected to the fluid outlet connections 20 of the other battery modules 1. The cooling medium thus flows into the fluid outlet 105 and out of the battery 100 during operation.

In the embodiments shown, as can be seen in FIG. 2 [sic: FIG. 2], the battery cells 3 are arranged in rows 28 running along the second direction R2, which are spaced apart from each other in a third direction R3. These rows 28 are also referred to below as cell rows 28. As can also be seen in FIG. 2 [sic: FIG. 2], successive rows of cells 28 in a third direction R3 are offset from one another in a second direction R2.

In the embodiment examples shown, the throttle openings 13 and the collector openings 19 are adapted to the arrangement of the battery cells 3 and in particular to their sequence. For this purpose, in the embodiments shown, as can be seen from FIGS. 4 and 5, the throttle openings 13 are arranged in rows 29 extending along the second direction R2 and spaced apart from one another in a third direction R3, which are also referred to below as throttle rows 29. In addition, successive throttle rows 29 in a third direction R3 are offset from each other in a second direction R2.

For this purpose, in the embodiments shown, as can be seen from FIGS. 6 and 7, the collector openings 19 are arranged in rows 30 extending along the second direction R2 and spaced apart from one another in a third direction R3, which are hereinafter also referred to as collector rows 30. In addition, in the embodiment examples shown, successive rows of collectors 30 in a third direction R3 are offset from one another in a second direction R2.

As can be seen from FIG. 4, in the embodiments shown, the distributor interruptions 23 are arranged in rows of interruptions 31 running along the second direction R2, which are spaced apart from one another in a third direction R3. Here, successive rows of interruptions 31 in a third direction R3 are offset from one another in a second direction R2.

As shown in FIGS. 4 and 5, the fluid distributor 7 can have at least one burst element 34, which is formed in the fluid distributor 7 as a recess 35 directed away from the cell volume 2. The respective burst element 34 is therefore raised on the side facing away from the cell volume 2 in a first direction R1. In the embodiment examples shown, the fluid distributor 7 has several such bursting elements 34. A distributor fin 16 of the fluid distributor 7 extends through at least one of the at least one bursting elements 34, in the embodiment examples shown through the respective bursting element 34.

In the embodiments shown, the respective intermediate plate 8 is designed as a thermal barrier, for example made of mica.

1. A battery, comprising:
at least two battery modules that follow one another in a first direction, wherein the at least two battery module respectively include:
a cell volume delimited in the respective battery module, in which battery cells are accommodated,
wherein the cell volume is open on a first side in the first direction,
a fluid distributor arranged on the first side and an intermediate plate arranged on a side of the fluid distributor facing away from the cell volume, which intermediate plate delimit a distributor volume,
wherein the fluid distributor has, on the side facing the intermediate plate, at least one fluid inlet connection with at least one inlet opening that is fluidically connected to the distributor volume, such that a flow path of a cooling medium leads through the at least one fluid inlet connection and via the at least one inlet opening into the distributor volume,
wherein the fluid distributor has throttle openings that are open in the first direction towards the cell volume and spaced apart from one another and which fluidically connect the distributor volume to the cell volume, such that the flow path leads from the distributor volume through the throttle openings into the cell volume,
a housing base arranged on a second side of the cell volume opposite the first side in the first direction, the housing base defines a collection volume with the intermediate plate of the next battery module,
wherein the housing base has spaced-apart collector openings that fluidically connect the cell volume to the collection volume, such that the flow path leads from the cell volume through the collector openings into the collection volume,
wherein the housing base has at least one fluid outlet connection with at least one outlet opening that is fluidically connected to the collection volumes, such that the flow path leads from the collection volume through the at least one outlet opening into the at least one fluid outlet connection,
wherein the at least one fluid inlet connection with the at least one inlet opening is spaced apart from the at least one fluid outlet connection with the at least one outlet opening in a third direction extending transversely to the first direction,
wherein the respective distributor volume decreases along the third direction starting from at least one of the at least one inlet openings,
wherein the respective collection volume, starting from at least one of the at least one outlet openings, decreases in the opposite direction along the third direction and the distributor volume.

2. The battery according to claim 1, wherein the respective intermediate plate runs inclined to the third direction, such that the respective distributor volume decreases along the third direction and the respective collection volume decreases in the opposite direction along the third direction and the respective distributor volume.

3. The battery according to claim 2, wherein:
the respective fluid distributor on the side facing the intermediate plate has distributor fins projecting in the first direction and spaced apart from one another in a second direction, on which the intermediate plate lies to form the distributor volume, and
a distributor fin height of the distributor fins extending in the first direction decreases along the third direction starting from at least one of the at least one inlet openings, such that the intermediate plate extends inclined to the third direction and the distributor volume decreases along the third direction.

4. The battery according to claim 2, wherein:
the respective housing base on the side facing away from the cell volume has collector fins projecting in the first direction and spaced apart from one another in a second direction, on which the intermediate plate of the next battery module lies to form the collection volume, and
a collector fin height of the collector fins extending in the first direction decreases along the third direction starting from at least one of the at least one outlet openings, such that the intermediate plate extends inclined to the third direction and the collection volume decreases along the third direction.

5. The battery according to claim 3, wherein the distributor fins respectively have at least one distributor interruption along the third direction, such that the flow path in the distributor volume passes through the distributor interruptions.

6. The battery according to claim 4, wherein the collector fins respectively have at least one collector interruption along the third direction, such that the flow path in the collection volume leads through the collector interruptions.

7. The battery module according to claim 4, wherein at least one of the collector fins has a main section extending along or inclined to the third direction, from which at least two arms project, such that a collector opening is arranged between the at least two arms.

8. The battery according to claim 1, wherein the battery cells of the respective battery module rest on or are supported on the housing base.

9. The battery according to claim 1, wherein the at least one fluid inlet connection with the at least one inlet opening is arranged along the third direction in a first edge of the associated distributor volume extending along a second direction.

10. The battery according to claim 9, wherein the at least one fluid outlet connection with the at least one outlet opening is arranged along the third direction in a second edge, extending along the second direction, of the associated collection volume, the second edge arranged opposite the first edge.

11. The battery according to claim 1, wherein:
the at least two battery modules include a first outer battery module in the first direction and a second outer battery module opposite the first outer battery module,
a first end plate that is arranged on the intermediate plate of the first outer battery module in a first direction, the first end plate has a fluid inlet for the respective fluid inlet connection of the first outer battery module for admitting the cooling medium into the battery, which fluid inlet is fluidically connected to the associated fluid inlet connection of the first outer battery module,
a second end plate that is arranged on the side of the housing base of the second outer battery module facing away from the cell volume in the first direction,
the second end plate has at least one fluid outlet for discharging the cooling medium from the battery, which is fluidically connected to the at least one fluid outlet connection of the second outer battery module.

12. The battery according to claim 11, wherein:
the first end plate has a first end plate inner surface that faces the intermediate plate of the first outer battery module in the first direction and on which the intermediate plate lies,
the first inner end plate surface is inclined towards the third direction, such that the distributor volume of the first outer battery module decreases along the third direction.

13. The battery according to claim 11, wherein:
the second end plate has a second end plate inner surface that faces the housing base of the second outer battery module in the first direction and on which the intermediate plate arranged between the housing base and the second end plate lies,
the second end plate inner surface is inclined towards the third direction, such that the collection volume of the second outer battery module decreases along the third direction.

14. The battery according to claim 1, wherein:
the fluid inlet connections of the at least two battery modules are fluidically connected to one another in a fluidically separate manner from the cell volumes, and/or
the fluid outlet connections of the battery modules are fluidically connected to one another separately from the cell volumes.

15. A motor vehicle, comprising:
a battery according to, the battery including:
at least two battery modules that follow one another in a first direction, wherein the at least two battery module respectively include:
a cell volume delimited in the respective battery module, in which battery cells are accommodated,
wherein the cell volume is open on a first side in the first direction,
a fluid distributor arranged on the first side and an intermediate plate arranged on a side of the fluid distributor facing away from the cell volume, which intermediate plate delimit a distributor volume,
wherein the fluid distributor has, on the side facing the intermediate plate, at least one fluid inlet connection with at least one inlet opening that is fluidically connected to the distributor volume, such that a flow path of a cooling medium leads through the at least one fluid inlet connection and via the at least one inlet opening into the distributor volume,
wherein the fluid distributor has throttle openings that are open in the first direction towards the cell volume and spaced apart from one another and which fluidically connect the distributor volume to the cell volume, such that the flow path leads from the distributor volume through the throttle openings into the cell volume,
a housing base arranged on a second side of the cell volume opposite the first side in the first direction, the housing base defines a collection volume with the intermediate plate of the next battery module,
wherein the housing base has spaced-apart collector openings that fluidically connect the cell volume to the collection volume, such that the flow path leads from the cell volume through the collector openings into the collection volume,
wherein the housing base has at least one fluid outlet connection with at least one outlet opening that is fluidically connected to the collection volumes, such that the flow path leads from the collection volume through the at least one outlet opening into the at least one fluid outlet connection,
wherein the at least one fluid inlet connection with the at least one inlet opening is spaced apart from the at least one fluid outlet connection with the at least one outlet opening in a third direction extending transversely to the first direction,
wherein the respective distributor volume decreases along the third direction starting from at least one of the at least one inlet openings,
wherein the respective collection volume, starting from at least one of the at least one outlet openings, decreases in the opposite direction along the third direction and the distributor volume,
wherein a second direction runs transversely to a Z-direction of the motor vehicle.

16. The motor vehicle according to claim 15, wherein the battery is a traction battery.

17. The motor vehicle according to claim 15, wherein the respective intermediate plate runs inclined to the third direction, such that the respective distributor volume decreases along the third direction and the respective collection volume decreases in the opposite direction along the third direction and the respective distributor volume.

18. The motor vehicle according to claim 17, wherein:
the respective fluid distributor on the side facing the intermediate plate has distributor fins projecting in the first direction and spaced apart from one another in the second direction, on which the intermediate plate lies to form the distributor volume, and
a distributor fin height of the distributor fins extending in the first direction decreases along the third direction starting from at least one of the at least one inlet openings, such that the intermediate plate extends inclined to the third direction and the distributor volume decreases along the third direction.

19. The motor vehicle according to claim 17, wherein:
the respective housing base on the side facing away from the cell volume has collector fins projecting in the first direction and spaced apart from one another in the second direction, on which the intermediate plate of the next battery module lies to form the collection volume, and
a collector fin height of the collector fins extending in the first direction decreases along the third direction starting from at least one of the at least one outlet openings, such that the intermediate plate extends inclined to the third direction and the collection volume decreases along the third direction.

20. The motor vehicle according to claim 15, wherein the second direction runs along an X-direction of the motor vehicle.
